(19) United States
(12) Patent Application Publication
(10) Pub. No.: US 2017/0264722 A1
(43) Pub. Date: Sep. 14, 2017

(54) ELECTRONIC DEVICE

(71) Applicant: Molex, LLC, Lisle, IL (US)

(72) Inventor: Guang-yong ZHONG, Shanghai (CN)

(73) Assignee: Molex, LLC, Lisle, IL (US)

(21) Appl. No.: 15/529,248

(22) PCT Filed: Dec. 4, 2015
(86) PCT No.: PCT/CN15/96460

§ 371 Date: May 24, 2017

(30) Foreign Application Priority Data
Dec. 5, 2014 (CN) 201410742598.1

(51) Int. Cl. H04M 1/02

(52) U.S. Cl. CPC H04M 1/0249; H04M 1/0266

(57) ABSTRACT

The present disclosure relates to a type of electronic device, comprising an internal circuit and a surface structure. The internal circuit comprises a circuit board, a feed portion, and a coupler. The surface structure comprises a rectangular display, a metal casing, an elongated metal plate, a connection element, a resonant element, and a dielectric material. The circuit board is provided with a reference plane and a transceiver installed thereon. The feed portion is electrically connected to the transceiver. The coupler is electrically connected to the feed portion. The rectangular display is located at the top portion of the electronic device. The metal casing is electrically connected to the reference plane of the circuit board, forming an integrated reference ground. The elongated metal plate is located on one side surface of the electronic device and is separated from the edge of the metal casing by a gap. The connection element is located within the gap and connects the elongated metal plate and the metal casing. The resonant element comprises a part of the edge of the elongated metal plate, the connection element, and a part of the edge of the metal casing connected to each other. The resonant element and the coupler are separated. The coupler is capacitively coupled to the resonant element. The dielectric material fills the gap.

### RELATED APPLICATIONS

This application is a national stage of PCT Application No. PCT/CN2015/096460, filed Dec. 4, 2015, which claims priority to Chinese Application No. 201410742598.1, filed Dec. 5, 2014, both of which are incorporated herein by reference in their entireties.

### TECHNICAL FIELD

This disclosure relates to a type of electronic device with an antenna structure.

### BACKGROUND ART

U.S. Pat. No. 8,270,914 discloses a type of sidewall structures for a device, where the sidewall structures may be implemented using conductive materials, and may be implemented as a conductive ring member that substantially surrounds the rectangular periphery of the display. The sidewall structures may serve as a bezel holding the display to the front face of the device. The sidewall structures may sometimes be referred to a bezel structures or bezel. The bezel extends around the periphery of the device and the display.

The bezel may be provided with one or more gaps. The gap lies along the periphery of the housing of the device and display, and is therefore sometimes referred to as a peripheral gap. The gap divides the bezel (i.e., there is generally no conductive portion of the bezel in the gap). The bezel and the gap (and its associated plastic filler structure) may form part of one or more antennas in the device. The internal conductive structures may include printed circuit board structures, frame members or other support structures, or other suitable conductive structures, where the conductive structures may be fed by coupling the radio-frequency transceiver across the ground antenna feed terminal and the positive antenna feed terminal.

Where the antenna feed terminal is not located in the vicinity of the gap, the electric field strength of the radio-frequency antenna signal in the vicinity of the gap may be accentuated, but if a user places a finger in the vicinity of the gap, it will disrupt the operations of the antenna.

The device in U.S. Pat. No. 8,270,914 only includes a metal bezel, however, while one frequently seeks for electronics products to be provided with a design with a tactile exterior design, and it is often expected that the housing will be manufactured of metal materials, yet due to its shielding effect, metal makes it impossible for the antenna's radiant energy to be smoothly broadcast outward. Therefore, the application of a fully metal housing to electronic products is an issue that still requires further efforts by the industry.

### SUMMARY OF THE DISCLOSURE

On the basis of the above problem, the purpose of the present disclosure is to correspondingly present a new electronic device provided with an antenna.

In order to achieve the above purpose, the technical solution adopted in the present disclosure is to provide a type of electronic device, comprising an internal circuit and a surface structure. The internal circuit comprises a circuit board, a feed portion, and a coupler. The surface structure comprises a rectangular display, a metal casing, an elongated metal plate, a connection element, a resonant element, and a dielectric material. The circuit board has a reference plane and a transceiver installed thereon. The feed portion is electrically connected to the transceiver. The coupler is electrically connected to the feed portion. The rectangular display is located at the top portion of the electronic device. The metal casing is electrically connected to the reference plane of the circuit board, forming an integrated reference ground. The elongated metal plate is located on one side surface of the electronic device and is separated from the edge of the metal casing by a gap. The connection element is located within the gap and connects the elongated metal plate and the metal casing. The resonant element comprises a part of the edge of the elongated metal plate, the connection element, and a part of the edge of the metal casing connected to each other. The resonant element and the coupler are separated. The coupler is capacitively coupled to the resonant element. The gap is filled with the dielectric material.

Preferably, the metal casing described herein comprises a lower shell, located on the bottom surface of the electronic device, where the lower shell is electrically connected to the reference plane of the circuit board.

Preferably, the metal casing described herein comprises an upper shell located on the top surface of the electronic device and a lower shell located on the bottom surface of the electronic device, where the lower shell is electrically connected to the reference plane of the circuit board, the lower shell and the upper shell are partially connected, the elongated metal plate is located between the upper shell and the lower shell, and the connection element is connected to the elongated metal plate and the upper shell, or connected to the elongated metal plate and the lower shell.

Preferably, the lower shell described herein achieves partial connection with the upper shell by means of two side plates respectively extending from the two sides of the lower shell to the upper shell.

Preferably, the elongated metal plate described herein extends to one corner of the electronic device, and curves to extend to connect with a side surface adjoining on the corner.

Preferably, the resonant element described herein includes a length, where the length consists of a multiple of the quarter wavelength of a radiation wave transmitted by the resonant element.

Preferably, the length of the resonant element described herein consists of an odd multiple of the quarter wavelength of a radiation wave transmitted by the resonant element.

Preferably, the feed portion described herein receives energy originating from the transceiver, and provides the energy to the coupler; the coupler couples the energy to the resonant element by means of capacitive coupling.

Preferably, when energy is received by the resonant element, the energy received by the resonant element is transmitted to the transceiver across the connection to the reference plane provided by the coupler by means of capacitive coupling and by the connection element.

Preferably, it further comprises a universal serial bus circuit, wherein the coupler and the universal serial bus circuit are separated, and the coupler is capacitively coupled to the universal serial bus circuit.

Preferably, the electronic device described herein comprises a metal casing for a universal serial bus connector, where the universal serial bus circuit comprises a ground circuit, and the reference plane of the circuit board is connected to the metal casing of the universal serial bus connector and to the ground circuit of the universal serial bus connector.

Preferably, the coupler described herein comprises a laser direct structuring layer.

The beneficial effects of the present disclosure are: the electronic device may utilize a fully metal casing without experiencing a screened state; the connection element is utilized to connect the metal plate to the upper shell and/or connect the metal plate to the lower shell, forming an antenna resonant element; the position of the connection element may be adjusted to obtain a radiation wave of the needed frequency; by coupling energy to the metal casing by means of a non-direct feed, one need not consider how the antenna feed contacts the metal casing, improving the convenience of the design; by coupling energy to the metal casing by means of a non-direct feed, it is possible to avoid giving rise to poor antenna performance problems owing to a poor contact during the production process. By utilizing the non-direct feed method, it is possible to improve bandwidth under the same antenna environment.

### BRIEF DESCRIPTION OF THE DRAWINGS

FIG. 1 is a diagram of the electronic device in one embodiment of the present disclosure.

FIG. 2 is another diagram of the electronic device in one embodiment of the present disclosure.

FIG. 3 is a decomposition diagram of the electronic device in one embodiment of the present disclosure.

FIG. 4 is another decomposition diagram of the electronic device in one embodiment of the present disclosure.

FIG. 5 is a diagram of the antenna system in one embodiment of the present disclosure.

FIG. 6 is another diagram of the antenna system in one embodiment of the present disclosure.

FIG. 7 is a diagram of the coupler and feed portion in one embodiment of the present disclosure.

FIG. 8 is another diagram of the coupler and feed portion in one embodiment of the present disclosure.

FIG. 9 is a diagram of the universal serial bus circuit in one embodiment of the present disclosure.

FIG. 10 is a diagram of another antenna system in one embodiment of the present disclosure.

FIG. 11 is a diagram of the coupler and feed portion of another antenna system in one embodiment of the present disclosure.

FIG. 12 is a resonance graph of one embodiment of the present disclosure.

FIG. 13 is a resonance graph of another embodiment of the present disclosure.

FIG. 14 is a resonance graph of another embodiment of the present disclosure.

FIG. 15 is a resonance graph of another embodiment of the present disclosure.

### DETAILED DESCRIPTION OF THE PREFERRED EMBODIMENTS

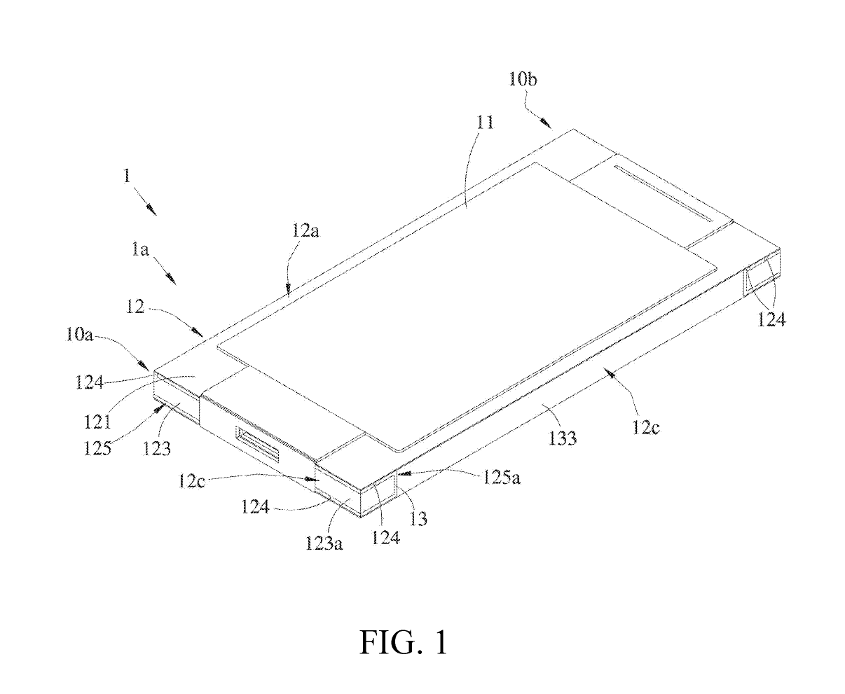

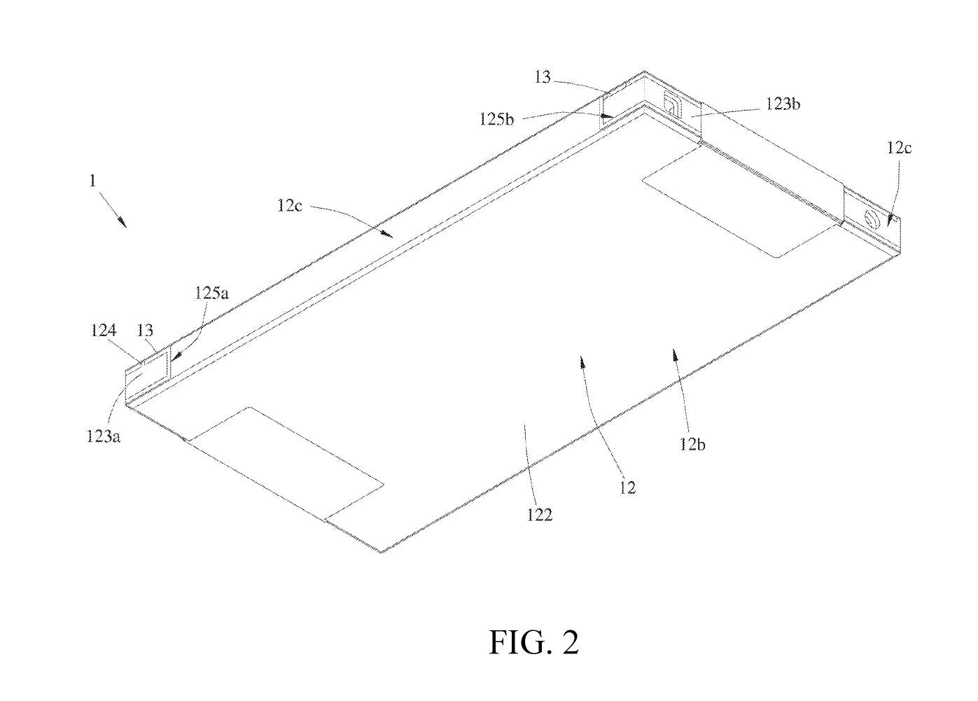

As shown in FIG. 1 and FIG. 2, in at least some embodiments, electronic device 1 comprises a wireless communications circuit, where the wireless communications circuit can support wireless communications on at least one wireless communications frequency band, and the wireless communications circuit may comprise one or multiple antennas.

In at least some embodiments, electronic device 1 may consist of a laptop computer or portable computer, mini notebook computer, tablet computer, and other small portable computers. Electronic device 1 may also consist of several even smaller electronic devices, such as: a wristwatch electronic device, pendant electronic device, head-mounted electronic device, headphone electronic device, or other wearable and miniature electronic devices. In at least some embodiments, electronic device 1 may consist of a handheld electronic device, such as: a cell phone, media player provided with wireless communications capabilities, handheld computer (sometimes also termed a personal digital assistant), remote control device, global positioning system (GPS) electronic device, or a handheld game electronic device.

In at least some embodiments, electronic device 1 supports high-frequency communications, such as: higher than 1 GHz. In some embodiments, electronic device 1 supports 1700 MHz to 2700 MHz. In at least some embodiments, electronic device 1 supports relatively low-frequency communications, such as: lower than 1 GHz.

As shown in FIG. 1, electronic device 1 may be generally rectangular, and may include a top surface, bottom surface, and multiple side surfaces. The side surfaces may be perpendicular to the top surface or bottom surface, but the present disclosure is not limited thereby. As shown in FIG. 1 to FIG. 11, electronic device 1 comprises surface structure 1a and internal circuit 1b. Surface structure 1a comprises rectangular display 11, metal casing 12, at least one elongated metal plate 123, 123a, or 123b, at least one connection element 124, resonant element 120, 120a or 120b, and dielectric material 13. Internal circuit 1b consist of at least one circuit board 14 or 14a, at least one feed portion 127 or 127a, and at least one coupler 126a, 126b or 126c.

Rectangular display 11 is located on the top surface of electronic device 1. Rectangular display 11 may consist of a touch display provided with capacitive touch electrodes. Rectangular display 11 may include image pixels formed by light-emitting diodes (LED), organic LED (OLED), plasma elements, electronic ink components, liquid crystal display (LCD) components, or other suitable image pixel structures. Electronic device 1 may include a protective glass cover component, and the protective glass cover component may cover the surface of rectangular display 11.

Metal plate 123, 123a or 123b is located on one side of electronic device 1. Metal plate 123, 123a or 123b is separated from the edge of metal casing 12 by means of the corresponding gap 125, 125a or 125b.

Connection element 124 is located within the corresponding gap 125, 125a or 125b, and connects metal casing 12 with the corresponding metal plate 123, 123a or 123b.

Resonant element 120, 120a or 120b comprises a part of the edge of metal plate 123, 123a or 123b, the corresponding connection element 124, and a part of the edge of metal casing 12 connected to each other. Resonant element 120, 12a or 120b is separated from the corresponding coupler 126a, 126b or 126c. Coupler 126a, 126b or 126c is capacitively coupled to the corresponding resonant element 120, 12a or 120b.

Dielectric material 13 fills gap 125, 125a or 125b. In some embodiments, dielectric material 13 may be plastic, glass, or sapphire, but the present disclosure is not limited thereby.

Circuit board 14 or 14a of internal circuit 1b is provided with reference plane 14 or 140a and transceiver 15 or 15a installed thereon. Metal casing 12 is electrically connected to reference plane 140 or 140a on circuit board 14 or 14a of internal circuit 1b, forming an integrated reference ground.

Feed portion 127 or 127a is electrically connected to the corresponding transceiver 15 or 15a. Coupler 126a, 126b or 126c is electrically connected to corresponding feed portion 127 or 127a. Feed portion 127 or 127a provides an input allowing the corresponding resonant element 120, 120a or 120b to emit energy (signal). Coupler 126a, 126b or 126c does not directly contact the corresponding resonant element 120, 120a or 120b or metal casing 12, which can reduce the complexity of the antenna design and improve reliability. In addition, the antenna on metal casing 12 adopts non-direct or indirect feed technology, which can effectively expand the antenna bandwidth.

In some embodiments, metal casing 12 comprises lower shell 122. Lower shell 122 is located on the bottom surface of electronic device 1. In some embodiments, connection element 124 connects lower shell 122 and the corresponding metal plate 123, 123a or 123b.

In some embodiments, metal casing 12 comprises upper shell 121 and lower shell 122. Upper shell 121 is located on the top surface of electronic device 1. Lower shell 122 is located on the bottom surface of electronic device 1. Lower shell 122 is electrically connected to the aforesaid reference plane 140 or 140a. Lower shell 122 and upper shell 121 are partially connected. Metal plate 123, 123a or 123b is located between upper shell 121 and lower shell 122. Connection element 124 connects the corresponding metal plate 123, 123a or 123b with upper shell 121, or connection element 124 connects the corresponding metal plate 123, 123a or 123b with lower shell 122.

Part of metal casing 12 may be used as an antenna. In some embodiments, at least one corner of metal casing 12 is used as an antenna. In some embodiments, a non-corner area of metal casing 12 may be used as an antenna. As shown in FIG. 1 through FIG. 6 and FIG. 10, in some embodiments, metal casing 12, metal plate 123, 123a or 123 and the corresponding connection element 124 cooperatively form conductive path 5, 5a, 5b or 5c, wherein conductive path 5, 5a, 5b or 5c passes through connection element 124, and current path 2a, 2b, 2c or 2d is located on the conductive path.

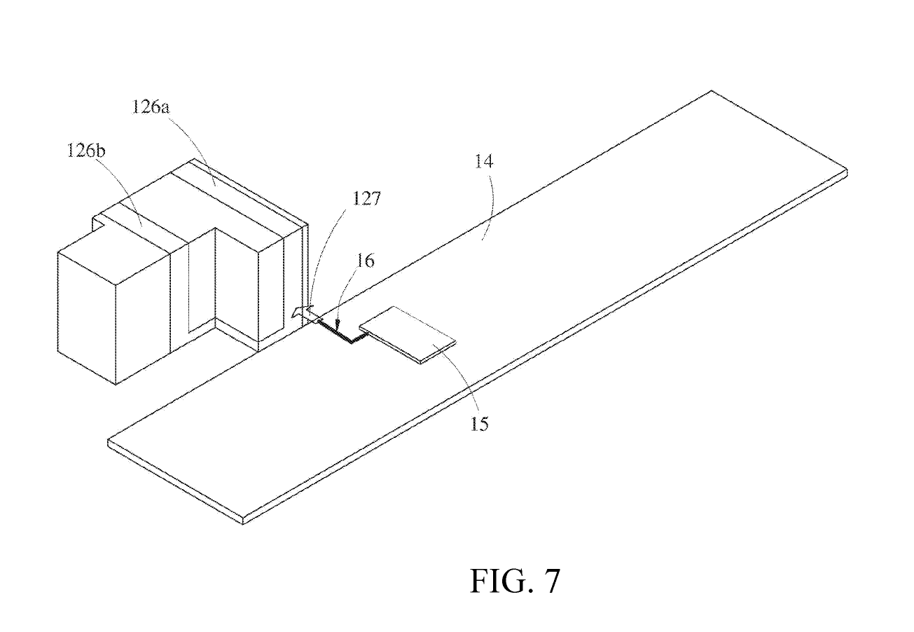

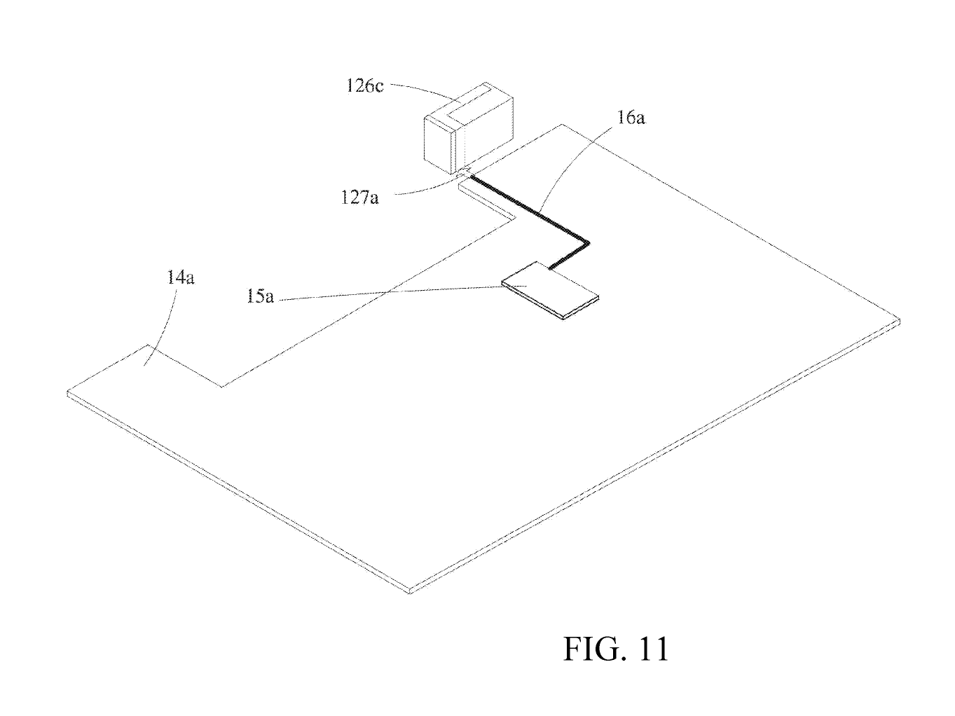

As shown in FIG. 7 and FIG. 11, feed portion 127 or 127a is connected to transceiver 15 or 15a through transmission line 16 or 16a. Feed portion 127 or 127a may include a circuit component, and the circuit component may provide one or multiple components with relatively good impedance matching between transceiver 15 or 15a and coupler 126a, 126b or 126c. Feed portion 127 or 127a electrically communicates with the corresponding transceiver 15 or 15a through transmission line 16 or 16a, and extends to connect to corresponding coupler 126a, 126b or 126c. Feed portion 127 or 127a may be composed of any appropriate conductive component, and in one embodiment, it may be provided with a resistance of approximately 50 ohms. Feed portion 127 or 127a receives energy originating from transceiver 15 or 15a (through transmission line 16 or 16a), and provides energy to the corresponding coupler 126a, 126b or 126c; coupler 126a, 126b or 126c couples the energy to the corresponding resonant element 120, 120a or 120b by means of capacitive coupling. Similarly, when the energy is being received by resonant element 120, 120a or 120b, the energy received by resonant element 120, 120a or 120b is transmitted to the corresponding transceiver 15 or 15a across the connection to reference plane 140 or 140a provided by coupler 126a, 126b or 126c by means of capacitive coupling and by connection element 124. In some embodiments, transmission line 16 or 16a consist of a circuit or a trace (trace) on a circuit board. In some embodiments, circuit board 14 and circuit board 14a may be integrated into one. In some embodiments, transceiver 15 and transceiver 15a may be integrated into one.

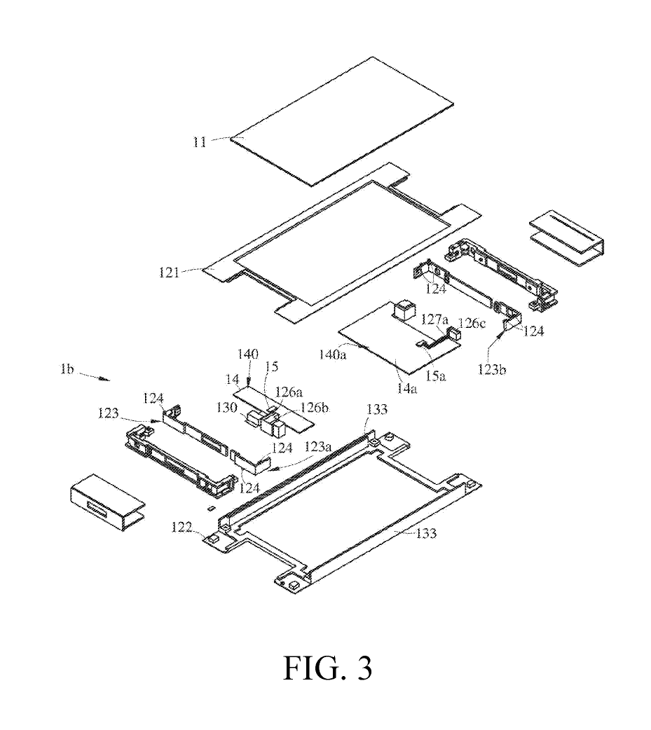

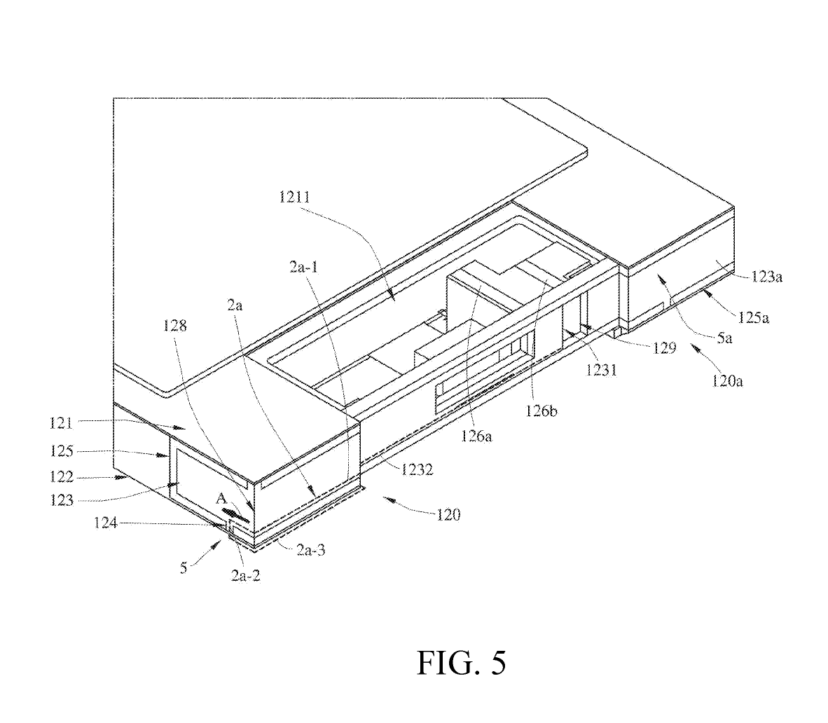

As shown in FIG. 3 to FIG. 8, in some embodiments, the antenna on metal casing 12 consists of a non-direct feed (indirect feed) antenna. As shown in FIG. 5 to FIG. 8, upper shall 121, lower shell 122, metal plate 123 and gap 125 cooperatively form resonant element 120. Electronic device 1 may further include coupler 126a and feed portion 127. Coupler 126a and resonant element 120 are electrically separated. Coupler 126a is capacitively connected to resonant element 120. Feed portion 127 is connected to coupler 126a. Coupler 126a does not directly contact resonant element 120 or metal casing 12, which can reduce the complexity of the antenna design and improve reliability. In addition, the antenna on metal casing 12 adopts non-direct or indirect feed technology, which can effectively expand the antenna bandwidth.

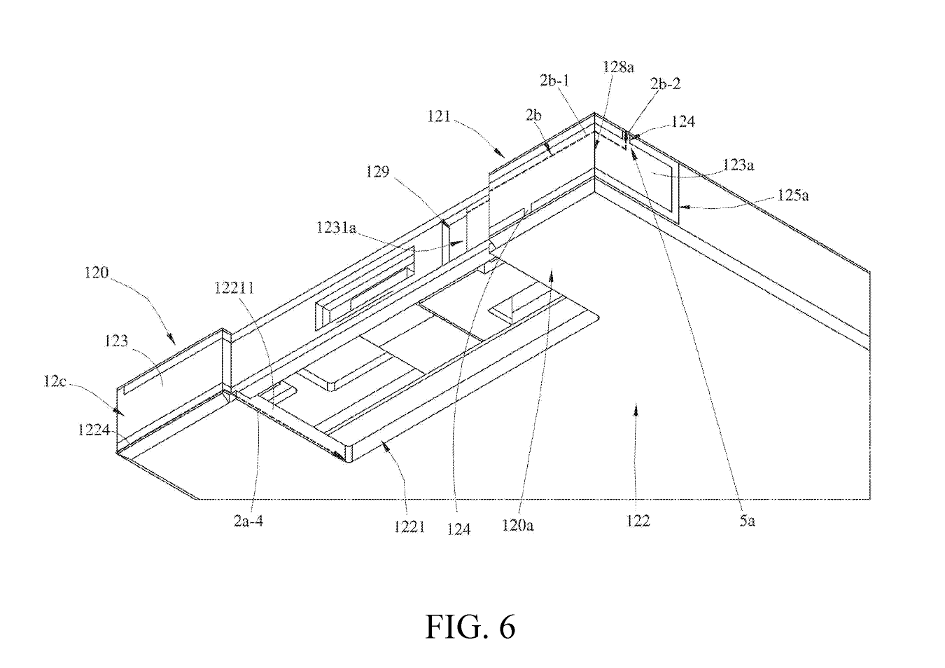

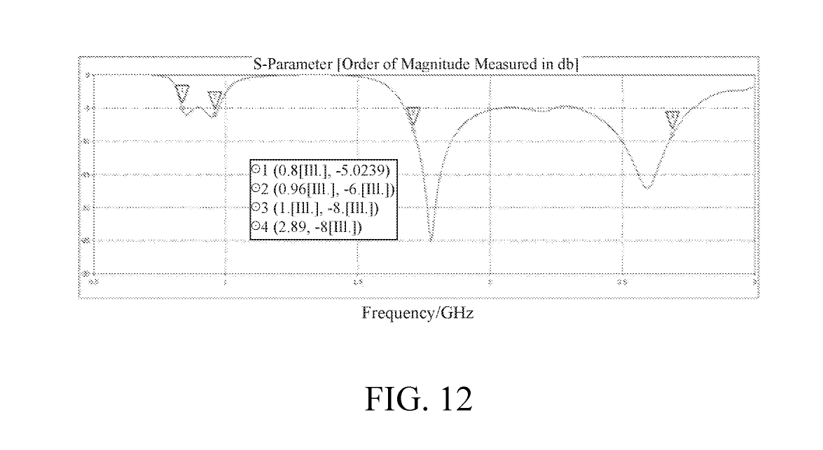

Resonant element 120 may be used to form the needed current paths, and generate the needed resonant frequencies. As shown in FIG. 5, FIG. 6, and FIG. 12, in some embodiments, lower shell 122 comprises concave portion 1221, where concave portion 1221 indents inward from side surface 12c. Connection element 124 connects lower shell 122. Resonant element 120 contains a length (generally consisting of the length of current path 2a), where the length is generally equivalent to a multiple or odd multiple of the quarter wavelength of a low-frequency radiation wave transmitted by resonant element 120. In some embodiments, the working frequency of the low-frequency radiation wave is GSM900, or even lower at GSM850; in some embodiments, the frequency generated by resonant element 120 is less than or equal to 960 MHz of radiation, as shown in FIG. 12. The length includes length 2a-1 of the long lower edge 1232 of metal plate 123 from extremity 1231 of metal plate 123 approaching relatively near to the center of side surface 12c to connection element 124 connecting lower shell 122; length 2a-2 of connection element 124 connecting lower shell 122; length 2a-3 of edge 1224 of lower shell 122 alongside gap 125 and located between connection element 124 and concave portion 1221; and length 2a-4 of side edge 12211 of concave portion 1221.

In some embodiments, when an adequate current path 2a can be provided, metal plate 123 may only be installed on side surface 12c of electronic device 1. If metal plate 123 is only installed on side surface 12c of electronic device 1, and it is not possible to provide current path 2a of an adequate length, metal plate 123 shall together extend from side surface 12c to corner 128 of electronic device 1, and curve to extend to connect with side surface 12c adjoining on corner 128, thereby providing current path 2a of an adequate length.

As shown in FIG. 5 and FIG. 6, electronic device 1 includes metal plate 123a. Metal plate 123a may be positioned on at least one side surface 12c of electronic device 1. In its installation on side surface 12, metal plate 123a is separated from the aforesaid metal plate 123 by separation 129. Metal plate 123a may be positioned between upper shell 121 and lower shell 122, and respectively separated from upper shell 121 and lower shell 122 by gap 125a. In some embodiments, electronic device 1 is generally rectangular, wherein separation 129 is located on a short side surface 12c of electronic device 1.

As shown in FIG. 3 to FIG. 8, upper shell 121, lower shell 122, metal plate 123a and another connection element 124 cooperatively form resonant element 120a. Coupler 126b is connected to feed portion 127, and furthermore is electrically separated from resonant element 120a, and capacitively coupled to resonant element 120a. Coupler 126b does not directly contact resonant element 120a or metal casing 12, which can reduce the complexity of the antenna design and improve reliability. In addition, the antenna on metal casing 12 adopts non-direct or indirect feed technology, which can effectively expand the antenna bandwidth.

In some embodiments, resonant element 120a may generate a relatively high-frequency radiation wave, such as: a radiation wave higher than 1.71 GHz, as shown in FIG. 12.

As shown in FIG. 6, in some embodiments, one connection element 124 is installed in gap 125a, and connects metal plate 123a with upper shell 121. In some embodiments, two connection elements 124 are installed in gap 125a, and the two connection elements 124 respectively connect metal plate 123a with upper shell 121, and connect metal plate 123a with lower shell 121 [sic].

As shown in FIG. 5, FIG. 6, and FIG. 12, in some embodiments, upper shell 121 includes concave portion 1211, where concave portion 1211 indents inward from side surface 12c. Resonant element 120a contains a length (generally consisting of the length of current path 2b), where the length is approximately equivalent to a multiple or odd multiple of the quarter wavelength of a high-frequency radiation wave transmitted by resonant element 120a. The length includes length 2b-1 of the long upper edge of metal plate 123a from extremity 1231a of metal plate 123 approaching relatively near to the center of side surface 12c, ending at connection element 124; and length 2b-2 of connection element 124.

In some embodiments, when an adequate current path 2b can be provided, metal plate 123a may only be installed on side surface 12c of electronic device 1. If metal plate 123 is only installed on side surface 12c of electronic device 1, but it is not possible to provide current path 2b of an adequate length, metal plate 123a shall together extend from side surface 12c to corner 128a of electronic device 1, and curve to extend to connect with side surface 12c adjoining on corner 128a, thereby providing current path 2b of an adequate length.

In some embodiments, only one of either metal plate 123 or metal plate 123a extends to the corner of electronic device 1. In some embodiments, metal plate 123 and metal plate 123a respectively extend to different corners of electronic device 1.

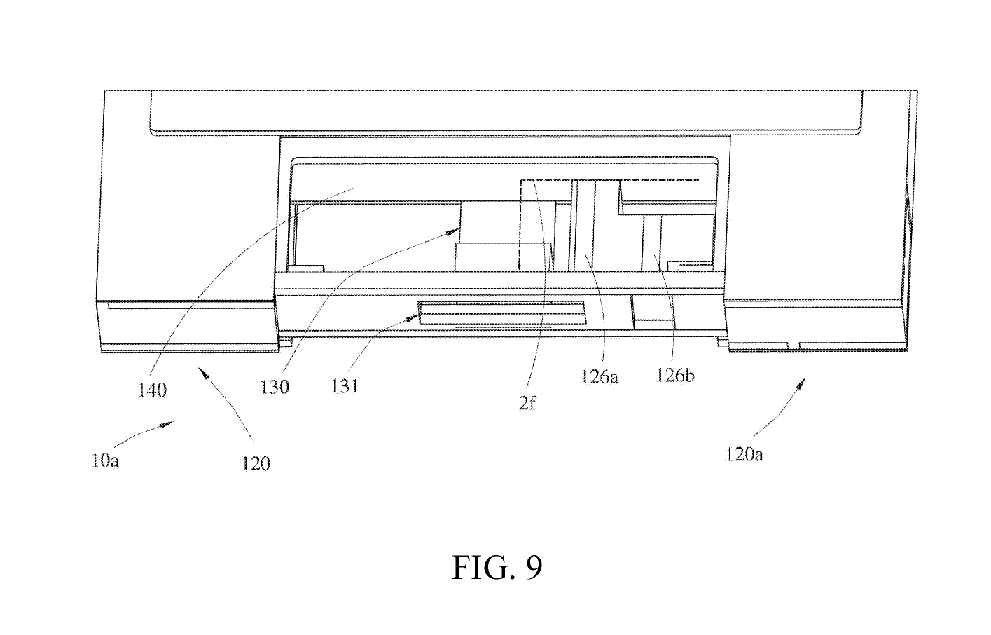

As shown in FIG. 3 and FIG. 9, in some embodiments, electronic device 1 comprises one circuit board 14, one transceiver 15, one metal casing 12, at least one metal plate 123 or 123a, at least one connection element 124, one dielectric material 13, one universal serial bus (USB) circuit 130, coupler 126b and one feed portion 127, wherein coupler 126b is capacitively coupled to USB circuit 130, and coupler 126b and USB circuit 130 are electrically separated. In some embodiments, electronic device 1 includes a metal casing for a USD connector, USB circuit 130 includes a ground circuit, and reference plane 140 of circuit board 14 connects the metal casing of the USB connector and the ground circuit of USB circuit 130. Coupler 126b may excite resonance or current path 2f, and current path 2f may be partially positioned on circuit board 14, and partially positioned on USB circuit 130. The length of circuit path 2f is generally equivalent to a multiple or odd multiple of the quarter wavelength of a second high-frequency wave transmitted by USB circuit 130. In some embodiments, USB circuit 130 may excite a radiation wave with frequency (frequency) of approximately 1.71 GHz, as shown in FIG. 12. In some embodiments, electronic device 1 includes USB port 131, wherein universal serial bus circuit 130 extends toward port 131. In some embodiments, universal serial bus circuit 130 may serve as a parasitic element of antenna system 10a comprising resonant element 120 and resonant element 120a. In some embodiments, the parasitic element resonates under a high-frequency working frequency band, such as 1.71 GHz.

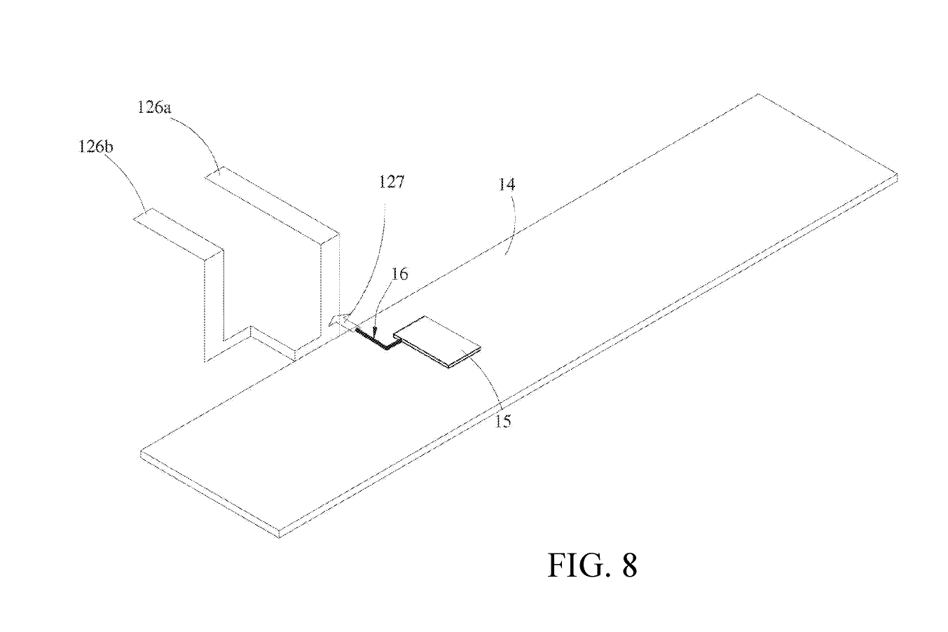

As shown in FIG. 7 and FIG. 8, in some embodiments, coupler 126a or 126b includes a metal sheet. In some embodiments, coupler 126a or 126b include a laser direct structuring (laser direct structuring) layer.

As shown in FIG. 1, in some embodiments, antenna system 10a is installed at one end of electronic device 1, and another antenna system 10b is installed at the other relative end of electronic device 1.

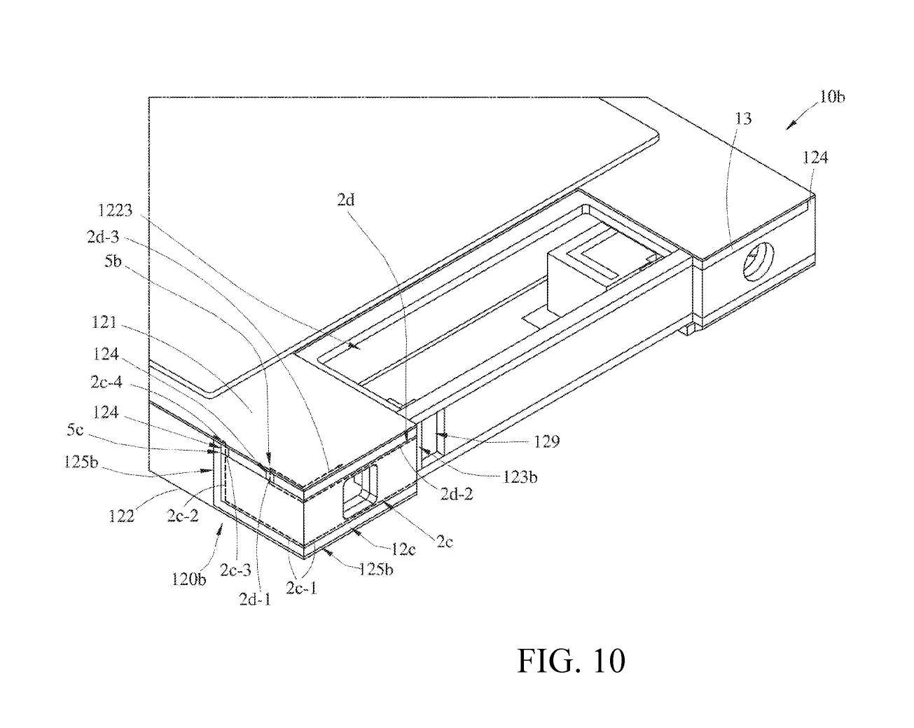

As shown in FIG. 1, FIG. 2, FIG. 10, and FIG. 11, electronic device 1 includes metal plate 123b and at least one connection element 124. Metal plate 123b is installed on another side surface 12c of electronic device 1. Metal plate 123b is located between upper shell 121 and lower shell 122, and is respectively separated from upper shell 121 and lower shell 122 by gap 125b. Connection element 124 is located within gap 125b, and connects metal plate 123b with upper shell 121. Dielectric material 13 fills gap 125b. Upper shell 121, lower shell 122, metal plate 123b and connection element 124 cooperatively form resonant element 120b of the other antenna system 10b. Electronic device 1 may further include coupler 126c and feed portion 127a. Coupler 126c is electrically separated from resonant element 120b. Coupler 126c is capacitively coupled to resonant element 120b. Feed portion 127a is connected to coupler 126c. Coupler 126c does not directly contact resonant element 120b or metal casing 12, which can reduce the complexity of the antenna design and improve reliability. In addition, the antenna on metal casing 12 adopts non-direct or indirect feed technology, which can effectively expand the antenna bandwidth.

Resonant element 120b may be used to form the needed current paths, and to generate the needed resonant frequencies.

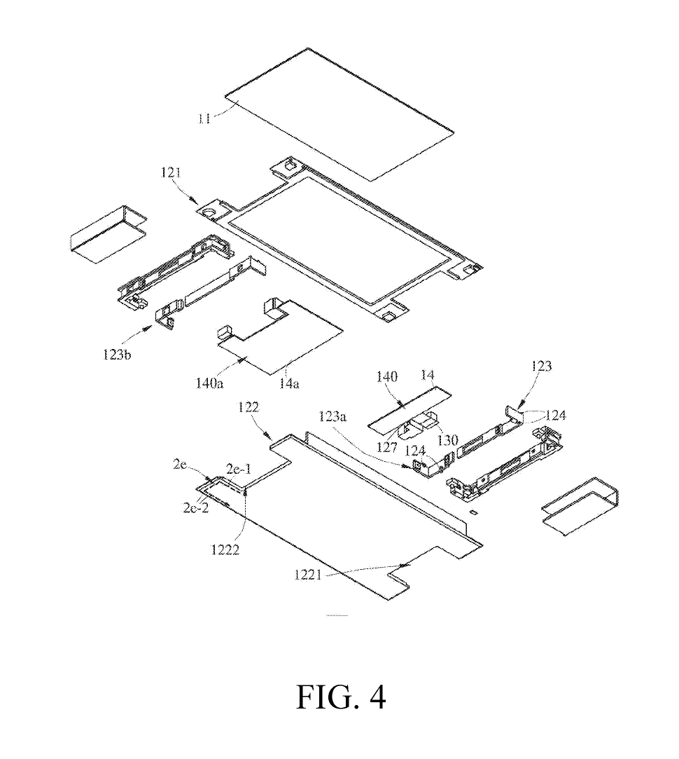

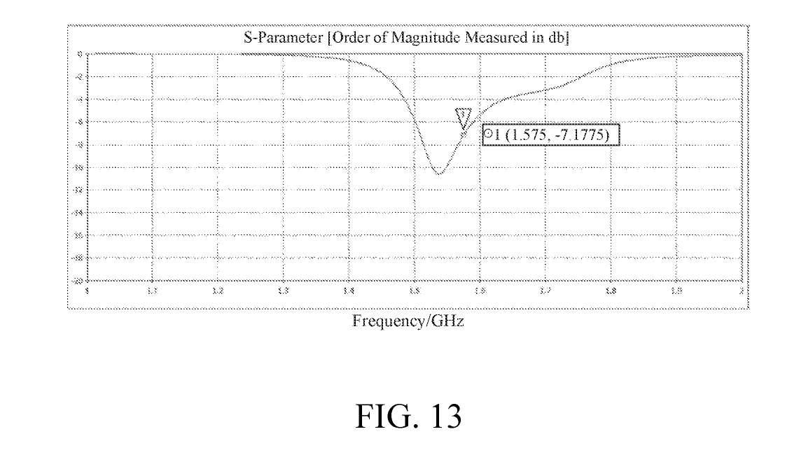

As shown in FIG. 4 and FIG. 10, in some embodiments, lower shell 122 includes concave portion 1222. Resonant element 120b contains a length (generally consisting of the length of current path 2c). The length is generally equivalent to a multiple or odd multiple of the quarter wavelength of the high-frequency radiation wave transmitted by resonant element 120b. In some embodiments, the frequency of the high-frequency radiation wave include GPS frequencies, as shown in FIG. 13. The length include length 2c-1 of the long lower end of metal plate 123b between the perpendicularly extending portion of gap 125b and concave portion of 1222, length 2c-2 of one end of metal plate 123b, length 2c-3 of connection element 124, and length 2c-4 of the edge of upper shell 121 above the perpendicularly extending gap 125b.

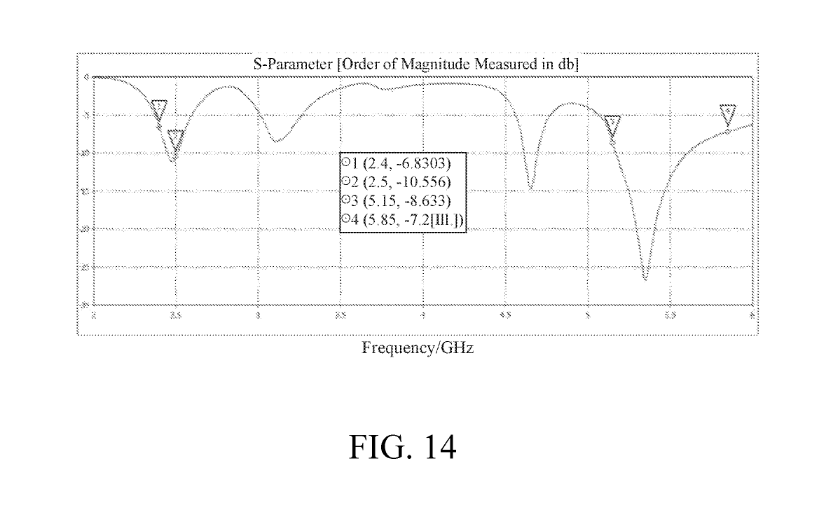

In some embodiments, upper shell 121 includes concave portion 1223. Resonant element 120b includes the other length (generally consisting of the length of current path 2d). The other length consists of a multiple or odd multiple of the quarter wavelength of the radiation wave transmitted by resonant element 120b. In some embodiments, the radiation wave includes WIFI 802.11b/g/n low-frequency radiation, such as 2.4 GHz WIFI radiation, as shown in FIG. 14. The other length includes length 2d-1 of connection element 124, length 2d-1 of the long upper edge of metal plate 123c alongside gap 125b between concave portion 1223 and connection element 124, and length 2d-3 of the partial edge of upper shell 121.

As shown in FIG. 4, in some embodiments, lower shell 122 includes concave portion 1222. Resonant element 120b includes an additional length (generally consisting of the length of current path 2e). The additional length consists of a multiple or odd multiple of the quarter wavelength of the radiation wave transmitted by resonant element 120b. In some embodiments, the radiation wave includes WIFI 802.11a/h/j high-frequency radiation, such as: 5.5 GHz WIFI radiation, as shown in FIG. 14. The additional length includes length 2e-1 of the edge of concave portion 1222, and length 2e-2 of the edge of lower shell 122 between concave portion 1222 and the perpendicularly extending gap 125.

As shown in FIG. 1 and FIG. 3, metal casing 12 includes two side plates 133. In some embodiments, lower shell 122 and upper shell 121 achieve partial connection by means of the two side plates 133 respectively extending from the two sides of lower shell 122 to upper shell 121. In some embodiments, the two side plates 133 respectively extend from the two sides of upper shell 121 to lower shell 122, to achieve partial connection.

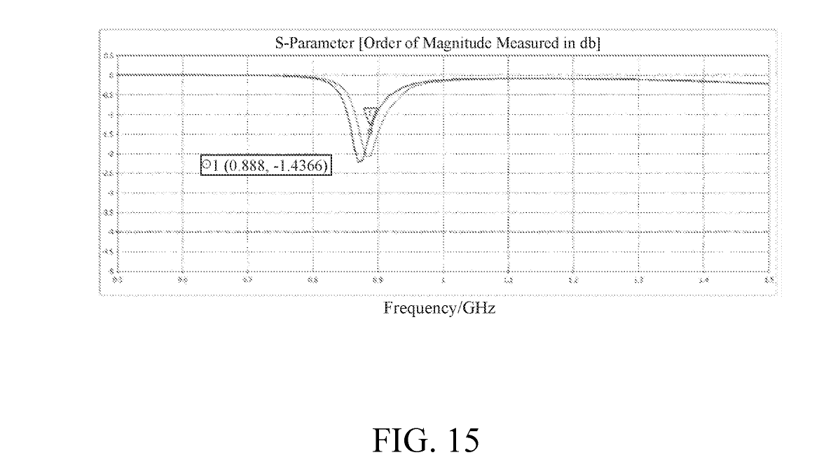

In some embodiments, in some embodiments, as shown in FIG. 5 and FIG. 15, when connection element 124 of resonant element 120 moves toward the central position in electronic device 1 (in the direction as shown by Arrow A), resonant element 120 will generate a relatively low-frequency radiation wave. Therefore, by adjusting the position of the connection element, it is possible to obtain a radiation wave of the needed frequency.

In some embodiments, the electronic device include a metal casing. Part of the metal casing is used as an antenna. Directly using part of the metal casing as an antenna can simplify the design and manufacturing of the electronic device. Directly using part of the metal casing as an antenna can allow the electronic device to more easily achieve the objective of using a fully metal casing.

In some embodiments, the electronic device includes an upper shell, lower shell and metal plate. The metal plate is located on one side surface of the electronic device. The metal plate is separated from the upper shell. The metal plate is separated from the lower shell. The connection element is utilized to connect the metal plate to the upper shell and/or connect the metal plate to the lower shell, so as to form an antenna resonant element.

In some embodiments, the connection element is utilized to cause the antenna resonant element to contain a length at a multiple or odd multiple of the quarter wavelength of a transmittable radiation wave, thus generating resonance. In some embodiments, examples of the above include a main antenna, GPS antenna, and WIFI antenna, but are not limited thereby, for instance: MIMO and other antennas are also included in the present disclosure.

In some embodiments, the antenna resonant element is directly electrically connected to the metal casing of the reference plane, which can effectively eliminate static electricity, thus effectively protecting the electronic equipment.

In some embodiments, power is coupled to the metal casing by means of a non-direct feed method, and one need not consider how the antenna feed contacts the metal casing, improving the convenience of the design. By coupling power to the metal casing by means of a non-direct feed, it is possible to avoid giving rise to poor performance problems owing to a poor contact during the production process. In addition, by using the non-direct feed method, it is possible to improve bandwidth under the same antenna environment.

The technical content and technical features of the present disclosure are as disclosed above, however, technical personnel in this field may still make various substitutions or modifications on the basis of the instructions and disclosures of the present disclosure which do not deviate from the spirit of the present disclosure. Therefore, the protected scope of the present disclosure should not be limited to the content disclosed in the Embodiments, but rather should include various substitutions or modifications which do not deviate from the spirit of the present disclosure, and encompass the scope of the claims listed in the attached Patent Claims.

1. An electronic device, the electronic device comprising:
an internal circuit, wherein the internal circuit comprises:
a circuit board, wherein the circuit board is provided with a reference plane and a transceiver installed thereon;
a feed portion, wherein the feed portion is electrically connected to the transceiver; and
a coupler, wherein the coupler is electrically connected to the feed portion; as well as a surface structure, wherein the surface structure comprises:
a rectangular display, wherein the rectangular display is positioned on the top face of the electronic device;
a metal casing, wherein the metal casing is electrically connected to the reference plane of the circuit board;
an elongated metal plate, wherein the elongated metal plate is positioned on a side surface of the electronic device, and is separated from the edge of the metal casing by a gap;
a connection element, wherein the connection element is positioned in the gap, and connects the elongated metal plate and the metal casing;
a resonant element, wherein the resonant element comprises part of the edge of the elongated metal plate, the connection element, and a part of the edge of the metal casing connected to each other; the resonant element is separated from the coupler, and the coupler is capacitively connected to the resonant element; and
a dielectric material, wherein the dielectric material fills the gap.

2. The electronic device according to claim 1, wherein the metal casing includes a lower shell, and the lower shell is located on the bottom face of the electronic device, wherein the lower shell is electrically connected to the reference plane of the circuit board.

3. The electronic device according to claim 1, wherein the metal casing includes an upper shell positioned on the top face of the electronic device, and a lower shell positioned on the bottom face of the electronic device, wherein the lower shell is electrically connected to the reference plane of the circuit board, the lower shell and the upper shell are partially connected, the elongated metal plate is located between the upper shell and the lower shell, and the connection element connects the elongated metal plate and the upper shell or connects the elongated metal plate and the lower shell.

4. The electronic device according to claim 3, wherein the lower shell and upper shell achieve partial connection by means of two side plates respectively extending from the two sides of the lower shell to the upper shell.

5. The electronic device according to claim 1, wherein the elongated metal plate extends to one corner of the electronic device, and bends to extend to connect with a side surface adjoining on the corner.

6. The electronic device according to claim 1, wherein the resonant element include a length, and the length is a multiple of a quarter wavelength of a radiation wave transmitted by the resonant element.

7. The electronic device according to claim 1, wherein the length of the resonant element consist of an odd multiple of a quarter wavelength of a radiation wave transmitted by the resonant element.

8. The electronic device according to claim 1, wherein the feed portion receives energy originating from the transceiver, and provides the energy to the coupler; the coupler couples the energy to the resonant element by means of capacitive coupling.

9. The electronic device according to claim 1, wherein, when the energy is received by the resonant element, the energy received by the resonant element is transmitted to the transceiver across the connection to the reference plane provided by the coupler by means of capacitive coupling and by the connection element.

10. The electronic device according to claim 1, wherein the electronic device further includes a universal serial bus circuit, and the coupler and the universal serial bus circuit are electrically separated, wherein the couple is capacitively coupled to the universal serial bus circuit.

11. The electronic device according to claim 10, wherein the electronic device includes a metal casing for a universal serial bus connector, the universal serial bus circuit includes a ground circuit, and the reference plane of the circuit board is connected to the metal casing of the universal serial bus connector and the ground circuit of the universal serial bus circuit.

12. The electronic device according to claim 1, wherein the coupler includes a laser direct structuring layer.ve coupling and by the connection element.
